(19) United States
(12) Patent Application Publication
(10) Pub. No.: US 2024/0169079 A1
(43) Pub. Date: May 23, 2024

(54) FILE ACCESS BASED ON DIGITAL PRECENSE

(71) Applicant: INTERNATIONAL BUSINESS MACHINES CORPORATION, ARMONK, NY (US)

(72) Inventors: Joshua Alter, Amesbury, MA (US); Colin Willenborg, Minneapolis, MN (US); Logan Bailey, Atlanta, GA (US); Zachary A. Silverstein, Georgetown, TX (US)

(21) Appl. No.: 18/057,382

(22) Filed: Nov. 21, 2022

(51) Int. Cl. G06F 21/62

(52) U.S. Cl. CPC G06F 21/6209

(57) ABSTRACT

According to one embodiment, a method, computer system, and computer program product for explaining discourse is provided. The embodiment may include identifying a collaborative networked environment, wherein the collaborative networked environment includes a user interactive environment and a file repository. The embodiment may also include gathering data about the collaborative networked environment, including data about the presence of one or more users in the user interactive environment. The embodiment may further include determining access for the one or more users to a resource based on the gathered data.

### BACKGROUND

The present invention relates generally to the field of computing, and more particularly to file access.

File access is a series of procedures whereby file systems, databases, and web servers govern access to various files and information among users. Access often includes permission to read, write, or modify a file. File access control mechanisms may be paired with security mechanisms to ensure that authorized users, and only authorized users, have access to the relevant documents, or relevant parts of a document. An effective access control scheme can distribute access to the relevant users, and only the relevant users, efficiently.

### SUMMARY

According to one embodiment, a method, computer system, and computer program product for explaining discourse is provided. The embodiment may include identifying a collaborative networked environment, wherein the collaborative networked environment includes a user interactive environment and a file repository. The embodiment may also include gathering data about the collaborative networked environment, including data about the presence of one or more users in the user interactive environment. The embodiment may further include determining access for the one or more users to a resource based on the gathered data.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a process for selectively providing file access based on digital presence.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to file access. The following described exemplary embodiments provide a system, method, and program product to, among other things, provide access to files based on digital presence. Therefore, the present embodiment has the capacity to improve the technical field of file access processing by selecting users to provide access to based on presence in a collaborative digital environment.

As previously described, file access is a series of procedures whereby file systems, databases, and web servers govern access to various files and information among users. Access often includes permission to read, write, or modify a file. File access control mechanisms may be paired with security mechanisms to ensure that authorized users, and only authorized users, have access to the relevant documents, or relevant parts of a document. An effective access control scheme can distribute access to the relevant users, and only the relevant users, efficiently.

Users may determine and assign file access manually. However, manually providing access to files to a large number of users is impractical, and can lead to user error and security issues. Particularly, manually providing meeting attendees access to various documents relevant to the meeting may be time-consuming and slow. Users may need access to a file immediately after a meeting, and therefore require a system that assigns access faster than is possible for humans to achieve. As such, it may be advantageous to, among other things, automatically select users to gain access to a file based on presence in a digital environment.

According to one embodiment, a method for providing access to files based on digital presence. A collaborative networked environment may connect a user interactive environment and a file repository to one another. A user interactive environment may be, for example, a digital meeting or a chat group. Data may then be gathered about the collaborative networked environment, including data about the presence of one or more users. Users may then be assigned access to one or more resources, such as files in the file repository, based on gathered data.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

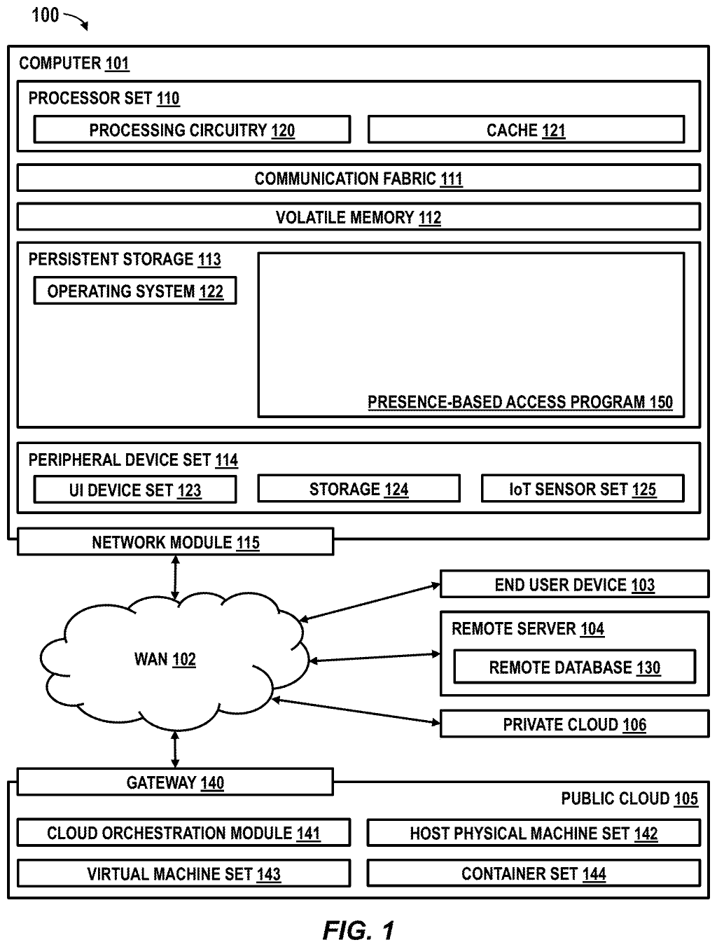

Referring now to FIG. 1, computing environment 100 contains an example of an environment for the execution of at least some of the computer code involved in performing the inventive methods, such as presence-based access program 150. In addition to presence-based access program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and presence-based access program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in presence-based access program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in presence-based access program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The presence-based access program 150 may connect a user interactive environment and a file repository to one another. The presence-based access program 150 may then gather data about the collaborative networked environment, including data about the presence of one or more users. Users may then be assigned access to one or more files in the file repository based on gathered data.

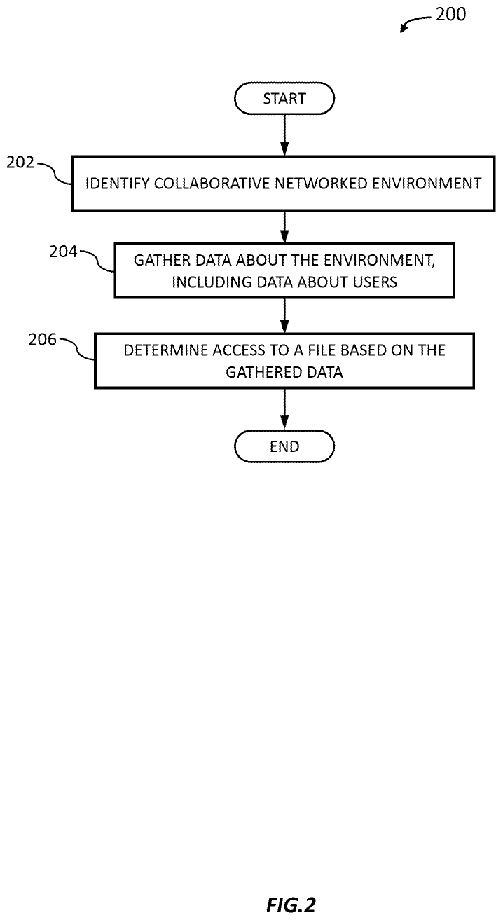

Furthermore, notwithstanding depiction in computer 101, presence-based access program 150 may be stored in and/or executed by, individually or in any combination, end user device 103, remote server 104, public cloud 105, and private cloud 106. The discourse explanation method is explained in more detail below with respect to FIG. 2.

Referring now to FIG. 2, an operational flowchart for a process for determining access based on user presence 200 is depicted according to at least one embodiment. At 202, the presence-based access program 150 identifies a collaborative networked environment, including at least one user interactive environment and at least one file repository. A user interactive environment may include a web conference, voice call, video call, live stream, chat group, or social media group. A file repository may include a cloud file repository or a file server. A collaborative networked environment may further include two or more users, one or more files, and a connection between a user interactive environment and a file repository.

In at least one embodiment, a user interactive environment is a web conference, audio call, video call, or live stream. A user interactive environment may include a feature that allows users to share video of their screens with one another, or share a view of a particular document. Video may further include, for example, video of a user or an in-person presentation. Audio may include, for example, human speech or music. A user interactive environment may further include, for example, a text chat feature, reaction features, or a feature to manually share a file, such as an agenda or presentation file.

A user interactive environment may also include a chat group. A chat group may include a one-on-one chat such as a Short Message Service chat, a single chat room such as an Internet Relay Chat room or a Signal® group chat (Signal and all Signal-based trademarks and logos are trademarks or registered trademarks of Signal Messenger LLC and/or its affiliates), a group of chat rooms such as a Slack® channel (Slack and all Slack-based trademarks and logos are trademarks or registered trademarks of Slack Technologies, Inc. and/or its affiliates), a Discord® server (Discord and all Discord-based trademarks and logos are trademarks or registered trademarks of Discord Inc. and/or its affiliates), or a Matrix space, or a single channel in such a group.

A chat service may enable the sending of text, photo, audio, and video messages and reactions to messages. A chat service may also include an audio channel,

A user interactive environment may further include a social media group. A social media group may include, for example, a simple group of users such as a Facebook® group (Facebook and all Facebook-based trademarks and logos are trademarks or registered trademarks of Meta Platforms, Inc. and/or its affiliates), an interest-based community such as a web forum or subreddit on Reddit® (Reddit and all Reddit-based trademarks and logos are trademarks or registered trademarks of Reddit, Inc. and/or its affiliates), a group of followers following a user, a group of individuals who a user follows, a group of people subscribed to a subscription service such as a Patreon® campaign (Patreon and all Patreon-based trademarks and logos are trademarks or registered trademarks of Patreon Inc. and/or its affiliates), or a chat group as described above. In an alternate embodiment, a user interactive environment may be a whole social network, or an instance of a social network, such as a Mastodon instance.

In at least one embodiment, a file repository may be a simple file server. A simple file server may be accessed, for example, by use of the Secure Shell Protocol (SSH). Permissions on a simple file server may, for example, be managed by operating system utilities such as chmod.

Alternatively, a file repository may be a cloud server or similar abstracted file server. Cloud servers may use cloud services such as Dropbox® (Dropbox and all Dropbox-based trademarks and logos are trademarks or registered trademarks of Dropbox, Inc. and/or its affiliates). Other examples of services using abstracted file servers may include Imgur® (Imgur and all Imgur-based trademarks and logos are trademarks or registered trademarks of Imgur, Inc. and/or its affiliates) and YouTube® (YouTube and all YouTube-based trademarks and logos are trademarks or registered trademarks of Google LLC and/or its affiliates). An abstracted file server may be accessed, for example, by Application Programming Interfaces (APIs).

A file repository may also be any other medium on which files are stored that can be connected to a user interactive environment, including an external hard drive connected by wired connection and operating system API.

A user interactive environment and file server may be connected, such as by webhooks, Hypertext Transfer Protocol (HTTP) requests, APIs such as Representational State Transfer (REST) APIs, or use of SSH. Additionally, multiple user interactive environments may be connected to one another, and multiple file servers may be connected to one another.

A collaborative networked environment may further include other connected devices and services, such as a user device, other services, network devices used to connect devices to one another, or a company's human resources database.

Then, at 204, the presence-based access program 150 gathers data about the collaborative networked environment, including the presence of one or more users. Data may be gathered according to opt-in procedures. The presence of a user may be measured in the context of the collaborative networked environment or a user interactive environment. Gathered data may additionally include audio data, visual data, text data from a chat message or post, or data regarding an event in the collaborative networked environment.

Presence may be measured in the context of a user interactive environment. Presence in a web conference, audio call, or video call may constitute attendance during the whole call or part of the call. Presence during a live stream may include participation as a presenter or viewer of the whole stream or part of the stream. Presence in a chat group may include membership in, online status in, or recent participation in the chat group. Presence in a social media group may include membership in, online status in, or recent participation in the group.

Alternatively, presence may be measured in the context of a collaborative networked environment. Presence in a collaborative networked environment may include presence in one or more of its interactive environments, recently having accessed the file repository, or presence in another connected service. For example, if a collaborative networked environment corresponds to a company, presence may correspond to being clocked in in the company's timekeeping system, or to being connected to the company's virtual private network.

Presence may be a binary measure, such as whether or not a user is present, or a graduated measurement, such as how recently a user has participated, the portion of a meeting at which a user was present, or the number of messages a user has sent in a chat group, or a combination of more than one measurement.

In at least one embodiment, identifying the presence of users may further include identifying particular roles for users. For example, a user may be a meeting host, meeting presenter, forum moderator, or chat group administrator. User roles may be set, for example, manually by users, including administrative users or the users to whom the roles are assigned, or by software, including by the presence-based access program 150. Software used to set user roles may access other sources of data obtained using opt-in procedures, like a company's human resources database. Alternatively, such software may use artificial intelligence techniques to identify user roles.

Identifying the presence of users may further include identifying other information about users obtained using opt-in procedures, including user names, locations, time zones, user preferences, and any other information that may be useful for determining access, or supporting the presence-based access program 150, through machine learning, user interface improvements, security, or any other useful function.

In another embodiment, gathered data may include audio data, such as a recording of a voice, music, or any other audio content, including the audio portion of a video recording. Audio data may be shared live, as with a live voice conversation, or shared in a pre-recorded format, such as a music file played during a meeting. Audio data may correspond to a single audio stream from one user or a combined audio stream from one or more users, such as all presenters or all users. Audio data may be stored in a file repository, or may be processed live during a meeting.

Audio data may be analyzed using a variety of audio analysis techniques, including speech-to-text and artificial intelligence techniques such as cosine similarity and artificial neural networks. Artificial intelligence techniques may be used alongside machine learning. In one instance, a recording of music may be matched to a repository of music recordings and identified as a recording of a particular song.

In a further embodiment, gathered data may include visual data such as still images and video data. Video may include or be coupled with audio data. Visual data may be shared live, such as with a face-to-face conversation, or preexisting form, as with a video stream that contains pre-recorded segments or a photo shared to a social network. Video data may include data captured using a camera, screen share data, other data generated by a computer, or a combination thereof. For example, video data may include a recording of a user's face that is then filtered through an algorithm that makes the user look like a rabbit. Video data may be stored in a file repository, or may be processed live during a meeting.

Visual data may be analyzed using a variety of visual analysis techniques, including visual text recognition, object recognition and artificial intelligence techniques such as artificial neural networks. Artificial intelligence techniques may be used alongside machine learning. In the context of live video of an in-person presentation, video of presentation slides may be matched to a presentation file in the file repository, or an image file representing an image present in the presentation.

Screen share data may include a video stream, a paired audio stream, and other data regarding the environment the screen is being shared from. Other data may include a screen resolution, screen color information, or information about a file that is being shared on the screen. The environment the screen is being shared from may be connected to a file repository, allowing the presence-based access program 150 to identify a file being shared in a shared screen context by its location in the file repository.

Gathered data may further include text data from a chat message, post, attached document, audio data converted to text using text-to-speech, visual data converted using visual text recognition, or the text-based output of an artificial intelligence algorithm processing audio or visual data. For example, a file name visible in a screen share may say “meeting minutes.txt” and an administrative user's voice converted using text-to-speech may indicate “I will send you all an email with the meeting minutes after the call!”

Gathered data may further include data regarding an event in the collaborative networked environment. Events may include the detection of a keyword in audio, video, or text; the sharing of a document; the arrival or departure of a user from the collaborative networked environment or user interactive environment; the stopping or starting of any video or audio stream; the sending of a message; the posting of a post; the beginning of recording of a meeting; or an event manually triggered by a user.

Any gathered data may be used to train a machine learning model. The presence-based access program 150 may further gather data specifically for machine learning purposes, including feedback about the collaborative networked environment or about the presence-based access program 150.

Next, at 206, the presence-based access program 150 determines access to a resource for a set of users based on the gathered data. A resource may be, for example, a file in a file repository, a portion of a file, a file directory, a web page or set of web pages, a web service, or a future meeting. Determining access may include determining a level of access for each user, such as permission to view, edit, execute, delete, or copy a file; identifying a version of the file to be accessed; identifying a portion of the file to be access; or determining a time frame in which the file may be accessed.

In a preferred embodiment, a resource may be a file in a file repository. A file may include, for example, part of a file, a particular version of a file, the latest version of a file, or all versions of a file. For example, a resource may be the latest version of the meeting minutes, every version of a meeting recording, or the last version of a meeting presentation file saved before the end of the meeting at which a user was present (but no versions saved after the meeting).

In another embodiment, a resource may be a file directory. For example, a user may create a file directory with the meeting date as the name, and the presence-based access program 150 may determine that that directory is the resource to which some users should be granted access. Alternatively, the presence-based access program 150 may create a new file directory for each user, and create copies of the relevant files to place in each created directory.

In yet another embodiment, a resource may be a web page or set of web pages. For example, if a user interactive environment is a web forum, a resource may be a subforum for users who are present for a particular period of time, who were present before a given date, who have posted more than a given number of posts, or who have earned a given number of positive reactions.

In an alternate embodiment, a resource may be a future meeting. For example, if a user interactive environment was a meeting for a first training session in a series of training session, the resource may be the second training session in the series, or a digital credential signifying that a user may access the second training session.

A resource may be a file that is created or modified before, during, or after a meeting. For example, a meeting agenda may be created and modified before a meeting, meeting minutes may be created before or during a meeting and modified during and after the meeting, and a meeting recap may be created after the meeting.

In at least one embodiment, access may be determined and then granted by providing a file or a copy of a file directly to the appropriate user. For example, a file may be placed in a directory of a file system to which a user already has access, such as a user's “new recordings” folder in a cloud service. Alternatively, meeting minutes and a meeting agenda may be emailed directly to a user, or sent to the user in a messaging service. As another alternative, a user may be provided with a universal resource indicator (URI) linking to a file.

In an alternate embodiment, access may be determined and then provided to a user, such as an administrative user, moderator, or team leader, to review and grant. For example, a cloud service may include a pre-populated list of access changes to make as determined by the presence-based access program 150, with check boxes next to each, and provide the list next to an administrative user who may modify the list before hitting a “proceed” or “share” button to grant access according to the determinations. Alternatively, a list of users and determined recommended access levels may be emailed to a moderator on a web forum, who may further determine that most but not all of the recommended users should be granted access to a private subforum of the web forum.

In an alternate embodiment, access may be granted using a digital credential, user account, server-side flag associated with a user account, a secure token such as a token in a cryptocurrency wallet, or similar means of mediating access. For example, a digital credential may be a badge certifying that the user spent two hours in a leadership training seminar, or a secure token granting two further hours of credit towards an electrician's certification.

Access may be provided using a combination of these methods. For example, users may receive a URI to a file location in a cloud service, and may further have a server-side flag set on the cloud service granting them permission to use the file while they are logged into their user accounts on the cloud service.

Determining access may include determining a level of access for each user, such as permission to view, edit, execute, delete, or copy a file. For example, if a file server is a simple GNU®/Linux® (GNU and all GNU-based trademarks and logos are trademarks or registered trademarks of the Free Software Foundation and/or its affiliates. Linux and all Linux-based trademarks and logos are trademarks or registered trademarks of Linus Torvalds and/or his affiliates) file server, a level of access may be measured according to an octal digit indicating read, write, and execute permissions. Alternatively, levels of access on a cloud service may include permission to view, comment on, edit, and change the permissions for a file.

Determining access may also include identifying a version of the file to be accessed or identifying a portion of the file to be access, as discussed above. The presence-based access program 150 may grant access to more than one version of a file, such as all versions after a meeting began. A portion of a file may include, for example, the portion of the slides in a slide show that a user was present to view, or the portion of a recording of a meeting that a user was present for.

Determining access may further include determining a time frame in which the file may be accessed. For example, the presence-based access program 150 may determine that most users should only have access to the meeting recording for one week, but certain users should have permanent access to the meeting. Alternatively, users may be granted access to meeting minutes or recordings only one week after the meeting occurs, granting administrative users the ability to review and edit the minutes and recordings before access is granted. As another alternative, access to a digital credential may only last one year after a training session, after which a user must redo the training session to regain access to the digital credential.

Different users may be granted different levels of access, may be granted access to different files, or may be granted access to files under different circumstances. Some users may not be granted access to any resources.

In at least one embodiment, determining access may include simple determinations based on presence. For example, all users who are present for any portion of a meeting should have access to the meeting presentation, or all users who are present for more than 80% of the meeting should receive a digital credential for attending a meeting. Simple determinations may further be made based on settings set by a user. For example, a user may decide that all users present in a chat group before a certain date should receive access to a special emoticon pack.

Determining access may alternatively be performed according to a process of artificial intelligence. Determining access may further include gathering feedback regarding the determination of access, the level of access granted, the files access is granted to, or any other aspect of presence-based determination of access. Feedback may be gathered, for example, from users who receive access, or from users who review lists of recommended access. Feedback may be used in machine learning. Artificial intelligence and machine learning may include use of further techniques such as lexical analysis, sentiment analysis, and artificial neural networks.

It may be appreciated that FIG. 2 provides only an illustration of one implementation and does not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
identifying a collaborative networked environment, wherein the collaborative networked environment includes a user interactive environment and a file repository;
gathering data about the collaborative networked environment, including data about the presence of one or more users in the user interactive environment; and
determining access for the one or more users to a resource based on the gathered data.

2. The method of claim 1, wherein the determined access is provided as a recommendation to an administrative user.

3. The method of claim 1, wherein the resource is a file in the file repository.

4. The method of claim 1, wherein the collaborative networked environment establishes a connection between the user interactive environment and the file repository.

5. The method of claim 1, wherein the user interactive environment is a digital meeting.

6. The method of claim 5, wherein the resource is a record of the meeting in the form of meeting minutes or a recording of the meeting.

7. The method of claim 5, wherein the resource is a digital credential indicating that the user attended the meeting.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
identifying a collaborative networked environment, wherein the collaborative networked environment includes a user interactive environment and a file repository;
gathering data about the collaborative networked environment, including data about the presence of one or more users in the user interactive environment; and
determining access for the one or more users to a resource based on the gathered data.

9. The computer system of claim 8, wherein the determined access is provided as a recommendation to an administrative user.

10. The computer system of claim 8, wherein the resource is a file in the file repository.

11. The computer system of claim 8, wherein the collaborative networked environment establishes a connection between the user interactive environment and the file repository.

12. The computer system of claim 8, wherein the user interactive environment is a digital meeting.

13. The computer system of claim 12, wherein the resource is a record of the meeting in the form of meeting minutes or a recording of the meeting.

14. The computer system of claim 12, wherein the resource is a digital credential indicating that the user attended the meeting.

15. A computer program product, the computer program product comprising:
one or more computer-readable tangible storage medium and program instructions stored on at least one of the one or more tangible storage medium, the program instructions executable by a processor capable of performing a method, the method comprising:
identifying a collaborative networked environment, wherein the collaborative networked environment includes a user interactive environment and a file repository;
gathering data about the collaborative networked environment, including data about the presence of one or more users in the user interactive environment; and
determining access for the one or more users to a resource based on the gathered data.

16. The computer program product of claim 15, wherein the determined access is provided as a recommendation to an administrative user.

17. The computer program product of claim 15, wherein the resource is a file in the file repository.

18. The computer program product of claim 15, wherein the collaborative networked environment establishes a connection between the user interactive environment and the file repository.

19. The computer program product of claim 15, wherein the user interactive environment is a digital meeting.

20. The computer program product of claim 19, wherein the resource is a record of the meeting in the form of meeting minutes or a recording of the meeting.
